(19) United States
(12) Patent Application Publication
(10) Pub. No.: US 2006/0253776 A1
(43) Pub. Date: Nov. 9, 2006

(54) Information processing device, information processing system, information processing method, information processing program and recording medium recording the informaiton processing program

(75) Inventor: Tsutomu Ohkawa, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: PIONEER CORPORATION, Tokyo (JP); INCREMENT P CORPORATION, Tokyo (JP)

(21) Appl. No.: 11/401,483

(22) Filed: Apr. 11, 2006

(30) Foreign Application Priority Data
Apr. 12, 2005 (JP) 2005-114807

(51) Int. Cl. G06F 17/00

(52) U.S. Cl. 715/530; 715/517

(57) ABSTRACT

A file creating section of an editing terminal (200) of an information processing system recognizes module information associated with placement module information of template information and generates a web file in which module details information of the associated module information is embedded in a coordinate position corresponding to a placement coordinate position of the template information. Therefore, the web file can be easily created using the module information having been prepared in advance.

### BACKGROUND OF THE INVENTION

1. Field of the Invention

The present invention relates to an information processing device for processing information, an information processing system, an information processing method, an information processing program and a recording medium recording the information processing program.

2. Description of Related Art

There has been conventionally known software such as an application for creating a webpage (see, for instance, Document: JP-A-2001-331410, left column of page 3 to right column of page 4, FIGS. 1 to 5).

An arrangement disclosed in the Document includes an editor terminal and a user terminal for accessing a webpage via the Internet, a webpage-editing web server in which software for editing the webpage is installed and a production web server in which software for functioning as a web server is installed. When editing such as creation and modification of a webpage is performed, a user logins a system from the editor terminal to display an editing window. Then, by clicking an editing object selection area in the editing window, a page as an editing object is selected, and then, a layout template to be used is clicked and selected from a template name list displayed in a selection operation area. Then, a table name is selected from a table name list displayed in the editing operation area, and a table as an editing object is selected from a plurality of tables displayed in an editing image display area to determine a placement position of an object in the table. Then, a module template defining a placement position of a text, an image, link information or the like is selected, and information is input in the selected module template to incorporate the object in each table. Thereafter, the created webpage is converted into the HTML format to be stored in a page data storage section, allowing general Internet users to access the webpage. In the arrangement, in order to edit the webpage, by selecting a page name in the editing object selection area, the information of the webpage is extracted from the page data storage section to be editable.

In the conventional arrangement disclosed in the Document, the information of the webpage is extracted from the page data storage section when editing the created webpage again. However, when an object that is used in a plurality of webpages (e.g., a shop name, a title, etc.) is desired to be modified, each of the webpages has to be edited and modified, which is troublesome.

### SUMMARY OF THE INVENTION

An object of the present invention is to provide an information processing device capable of easily creating information as well as its system, its method, its program and a recording medium recording the program.

An information processing device according to an aspect of the present invention includes: a details information recognizer for recognizing details information about details of content; a template recognizer for recognizing plural pieces of template information having at least one piece of embedding frame information about an information embedding frame in which the details information is embedded; an information associator for selecting the details information that is embedded to the information embedding frame of the embedding frame information and associating the embedding frame information with the selected details information; and an information generator for generating content information for each of the plural pieces of template information, the content information being constructed as a single data structure in which, based on the template information and the details information associated with the embedding frame information of the template information, details of the details information associated with the embedding frame information is embedded in the information embedding frame.

An information processing system according to another aspect of the present invention includes: an editing device having the above-described information processing device of the present invention; and a server that is connectable to the editing device via a network, the server having a storage section for stores the content information transmitted from the editing section so that the content information is browsable on the network.

An information processing system according to another aspect of the present invention includes: a server having the above-described information processing device of the present invention; and a communicator that is connectable to the server via the network, the communicator transmitting the template information and the details information to the server.

An information processing method according to still another aspect of the present invention includes: recognizing details information about details of content, recognizing plural pieces of template information having at least one piece of embedding frame information about an information embedding frame in which the details information is embedded, selecting the details information that is embedded to the information embedding frame of the embedding frame information and associating the embedding frame information with the selected details information; and generating content information for each of the plural pieces of template information, the content information being constructed as a single data structure in which, based on the template information and the details information associated with the embedding frame information of the template information, details of the details information associated with the embedding frame information is embedded in the information embedding frame.

An information processing program according to yet another aspect of the present invention operates a computing unit to function as the above-described information processing device of the present invention.

An information processing program according to further aspect of the present invention operates a computing unit to execute the above-described information processing method of the present invention.

A recording medium according to still further aspect of the present invention records an information processing program records the above-described information processing program of the present invention in a manner readable by a computing unit.

### BRIEF DESCRIPTION OF THE DRAWINGS

FIG. 1 is a block diagram showing an outline of an information processing system according to an embodiment of the present invention;

FIG. 2 is a block diagram showing an outline of an editing terminal of the information processing system;

FIG. 3 is a schematic illustration showing an outline of a template table;

FIG. 4 is a schematic illustration showing an outline of a module table;

FIG. 5 is a schematic illustration showing an outline of a processor of an information processing device;

FIG. 6 is a schematic illustration showing an example of a template editing window displayed on a display section;

FIG. 7 is a schematic illustration showing an example of a module editing window displayed on the display section;

FIG. 8 is a schematic illustration showing an example of a preview window displayed on the display section;

FIG. 9 is a schematic illustration showing an example of a web order management window displayed on the display section;

FIG. 10 is a schematic illustration showing an example of a web top window at a time when a web file created by the information processing device is browsed on the display section;

FIG. 11 is a schematic illustration showing an example of a web article description window that is displayed on the display section when an article is selected in FIG. 10;

FIG. 12 is a schematic illustration showing an example of a web-article-purchase window that is displayed on the display section when a purchase of an article is selected in FIG. 11;

FIG. 13 is a block diagram showing an outline of a server of the information processing system;

FIG. 14 is a block diagram showing an outline of a server processing section of the server;

FIG. 15 is a flowchart showing web-file creation processing; and

FIG. 16 is flow chart showing order-receiving processing of the information processing system.

### DETAILED DESCRIPTION OF PREFERRED EMBODIMENT(S)

An embodiment of the present invention will be described below with reference to the attached drawings.

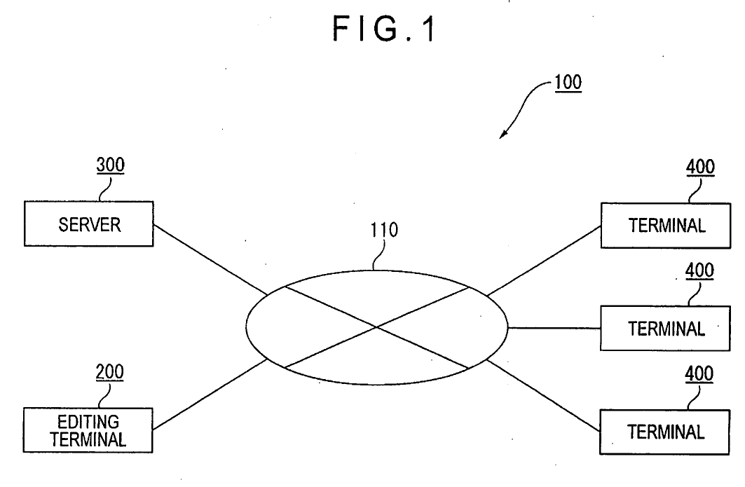

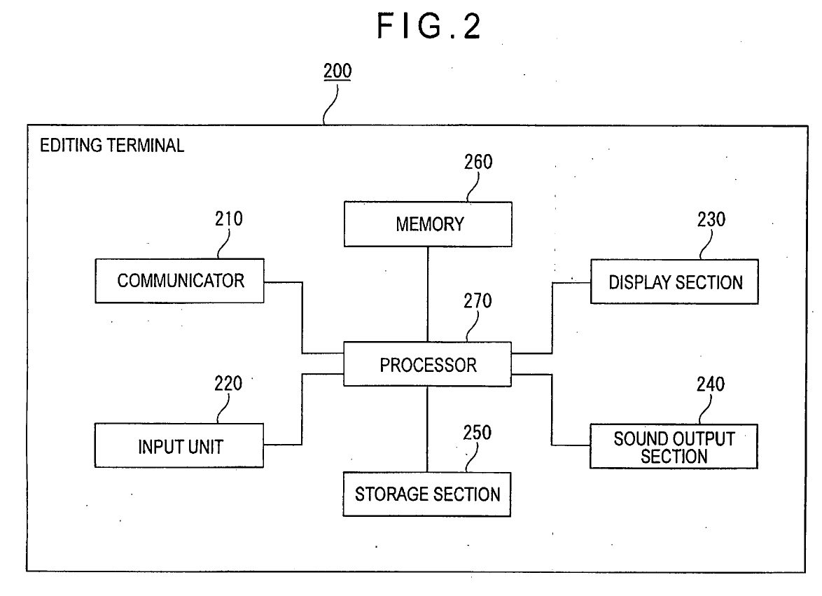

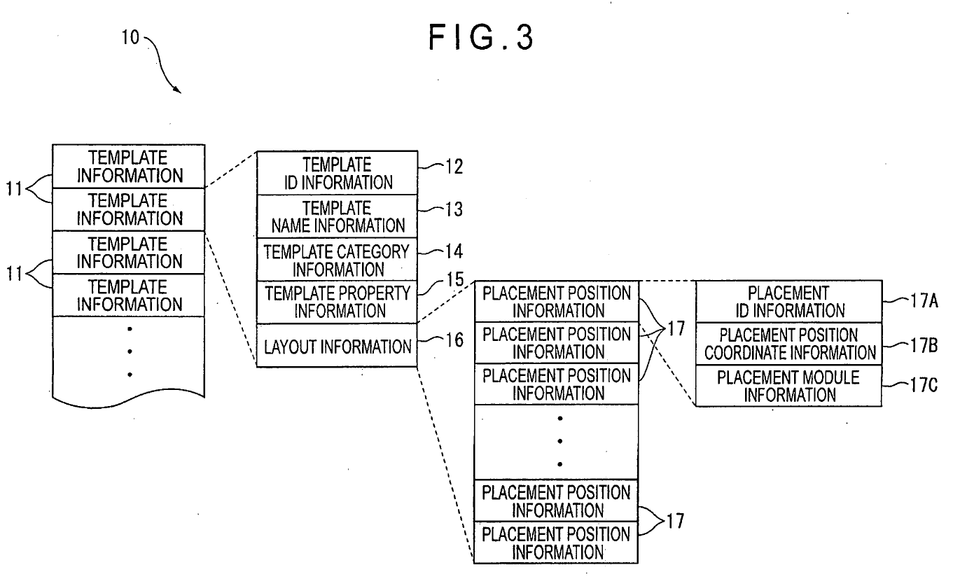

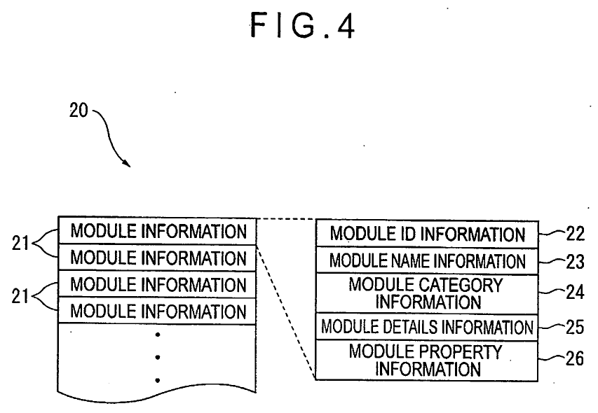

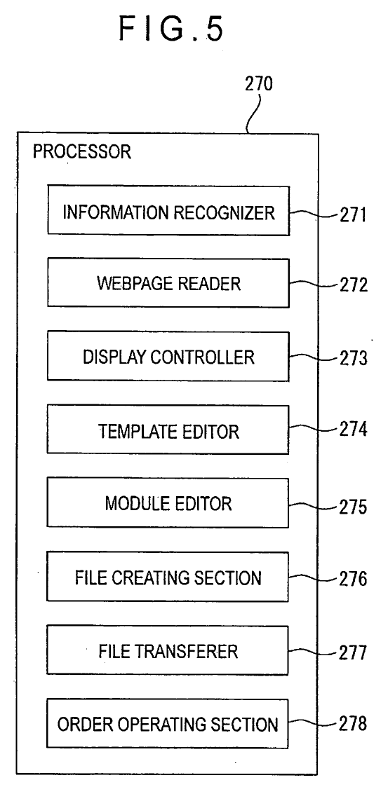

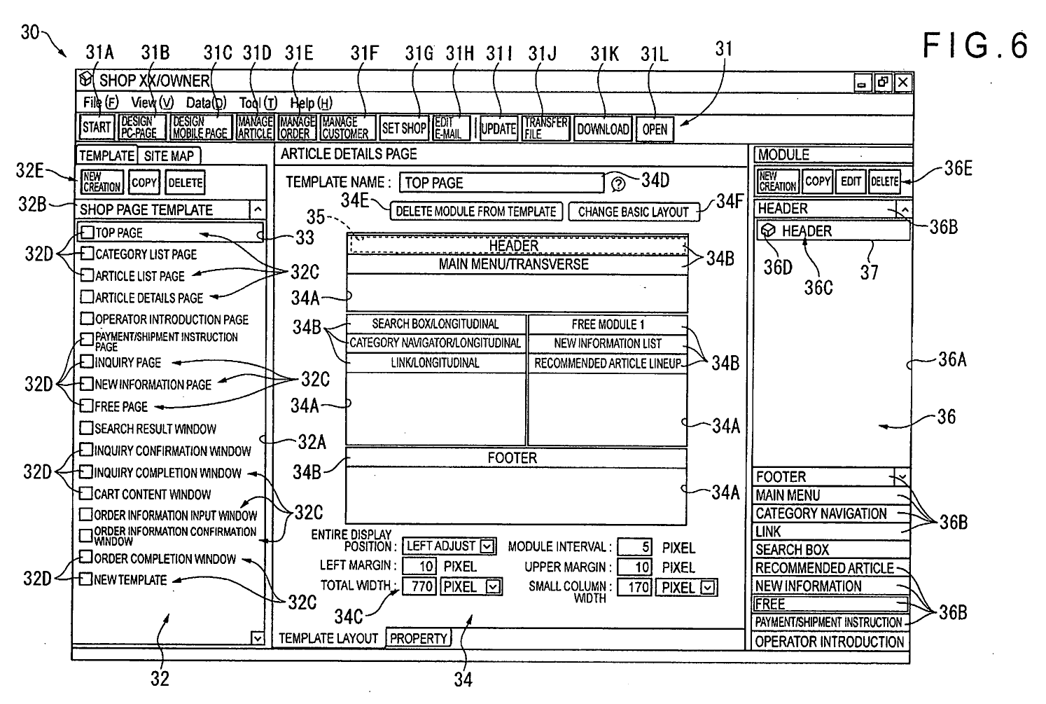

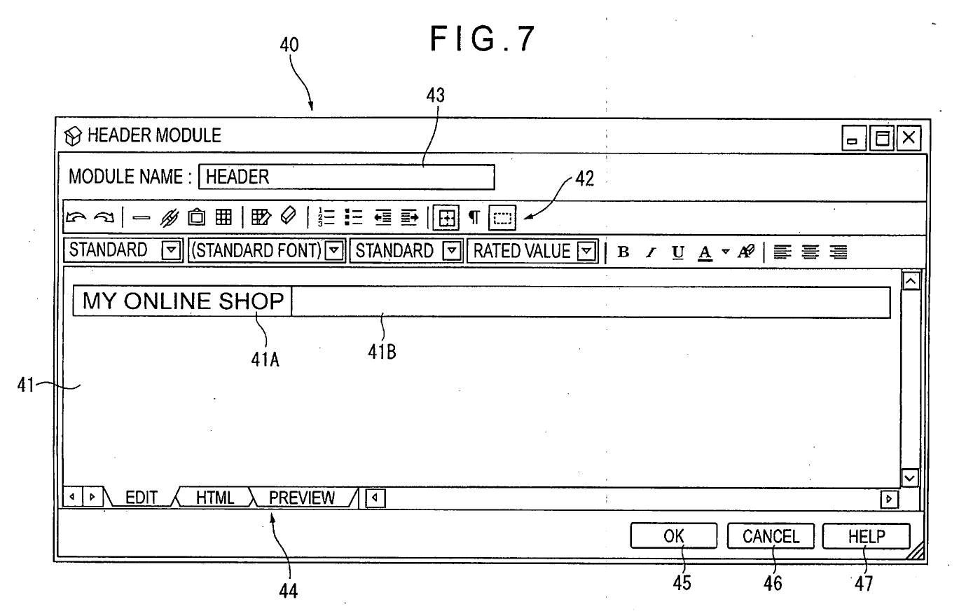

FIG. 1 is a block diagram showing an outline of an information processing system according to an embodiment of the present invention. FIG. 2 is a block diagram showing an outline of an editing terminal of the information processing system. FIG. 3 is a schematic illustration showing an outline of a template table. FIG. 4 is a schematic illustration showing an outline of a module table. FIG. 5 is a schematic illustration showing an outline of a processor of an information processing device. FIG. 6 is a schematic illustration showing an example of a template editing selection window displayed on a display section. FIG. 7 is a schematic illustration showing an example of a module editing window displayed on the display section.

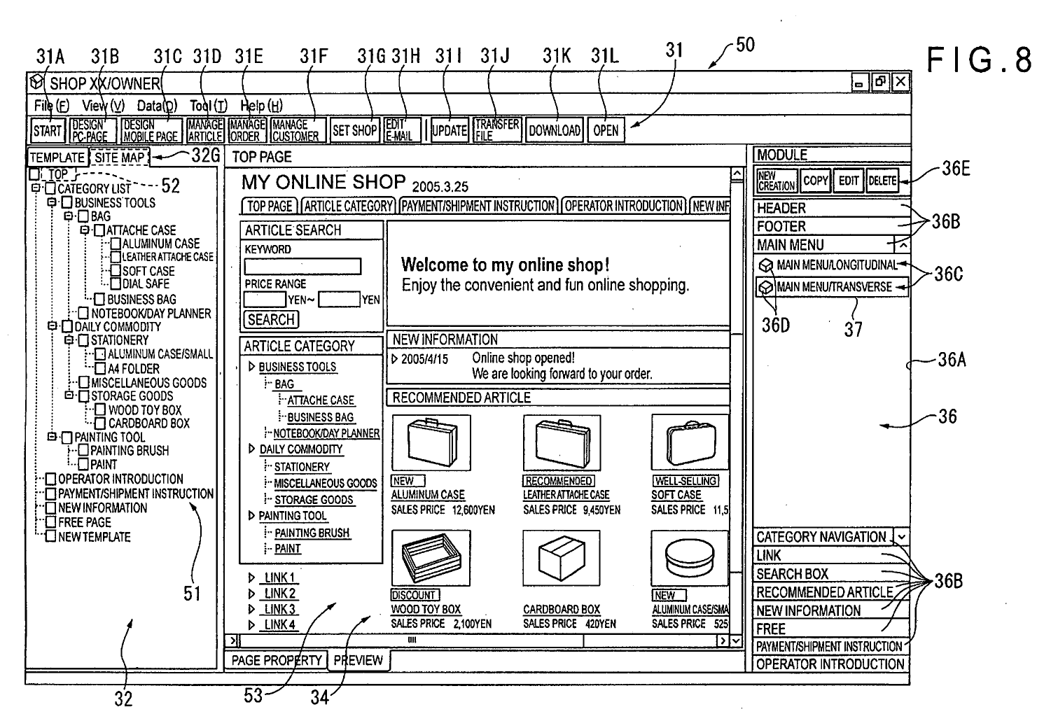

FIG. 8 is a schematic illustration showing an example of a preview window displayed on the display section.

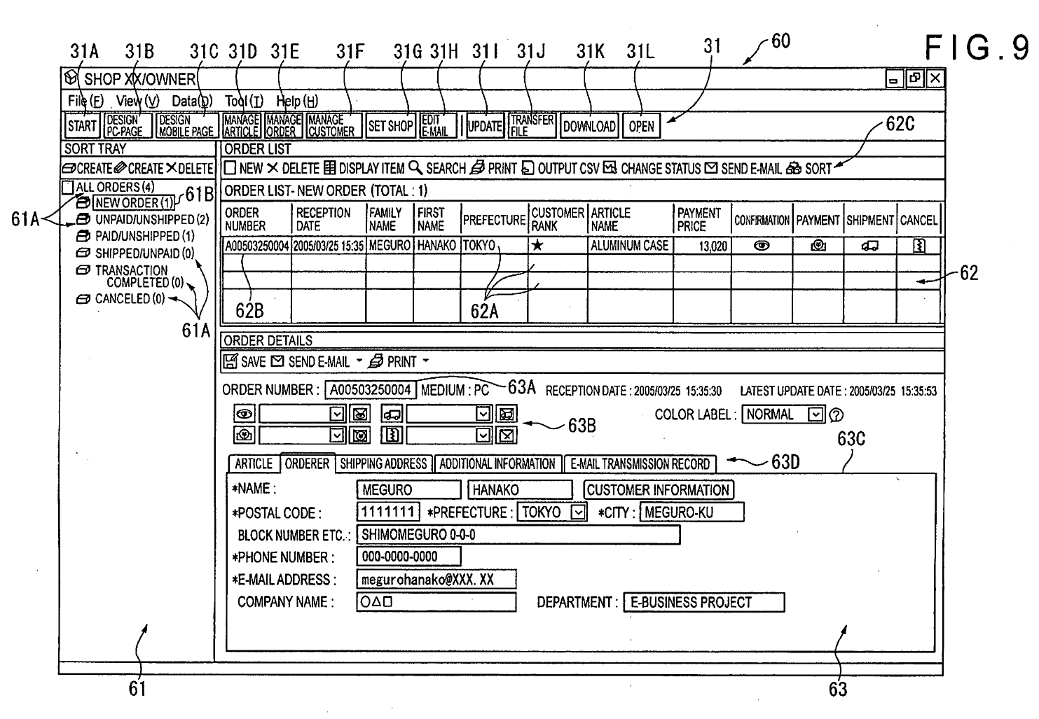

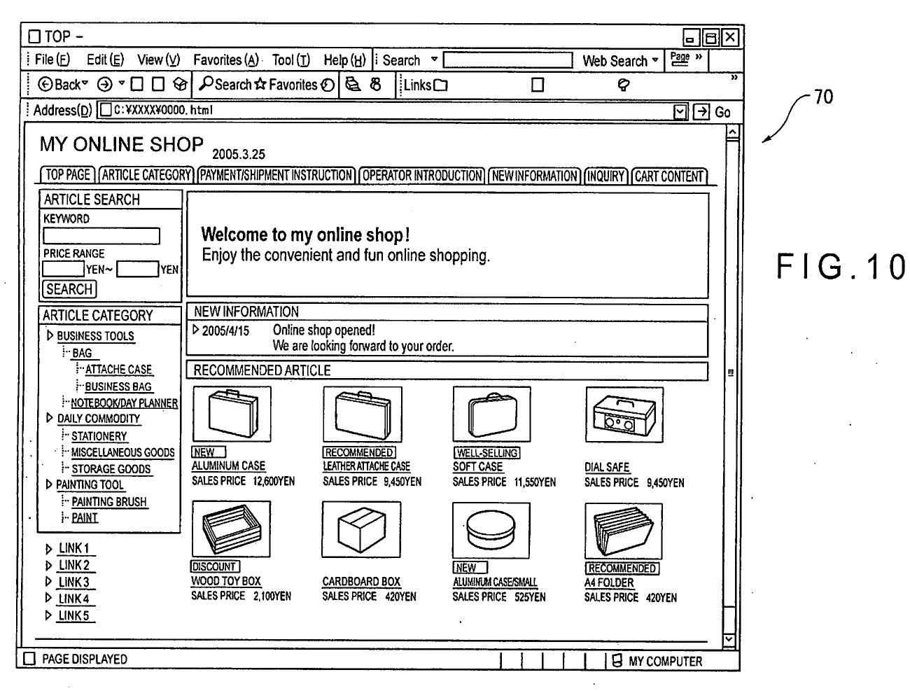

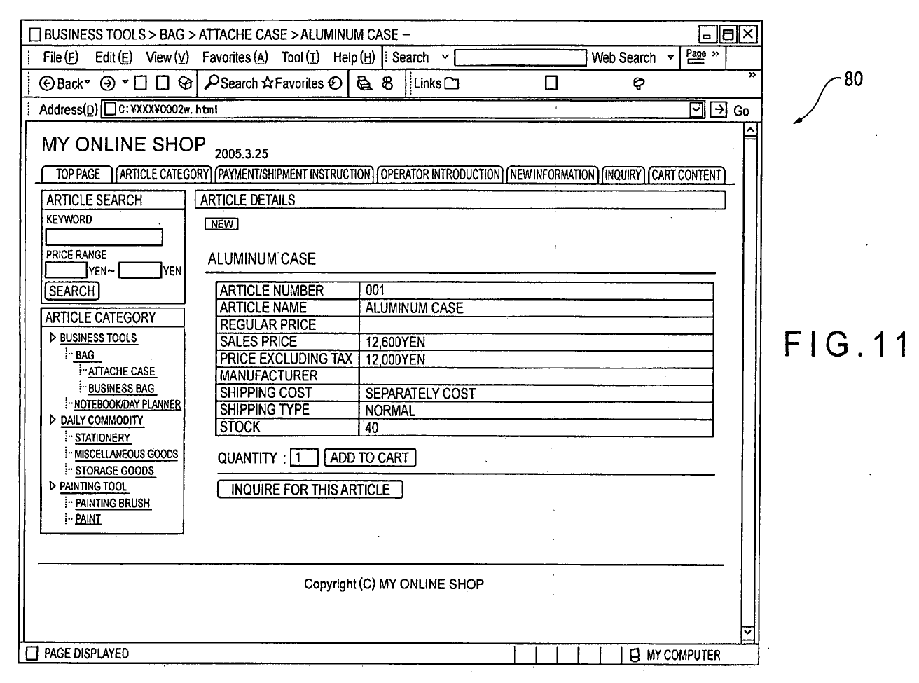

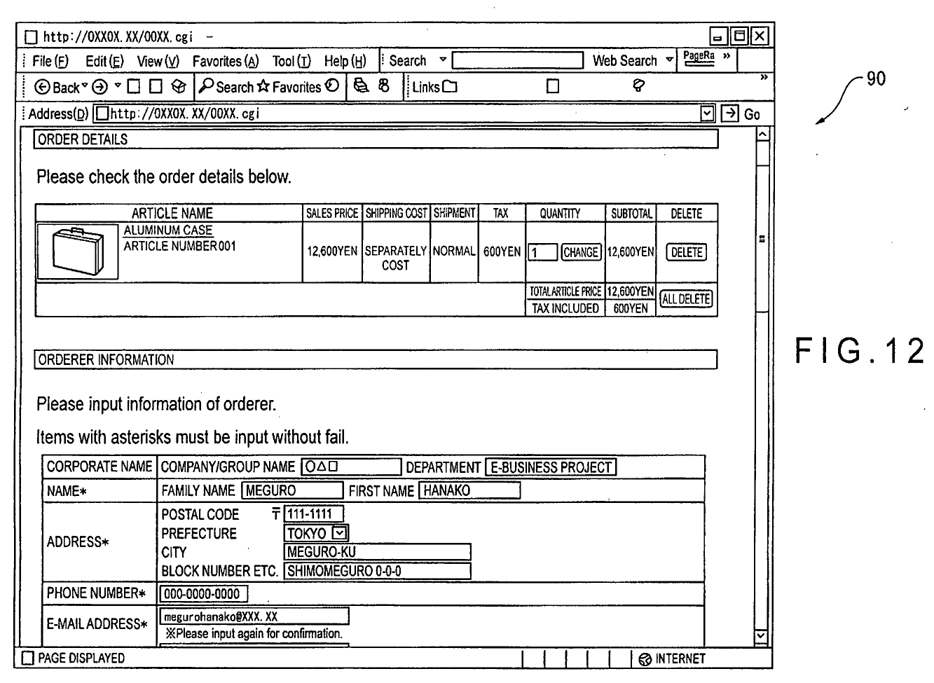

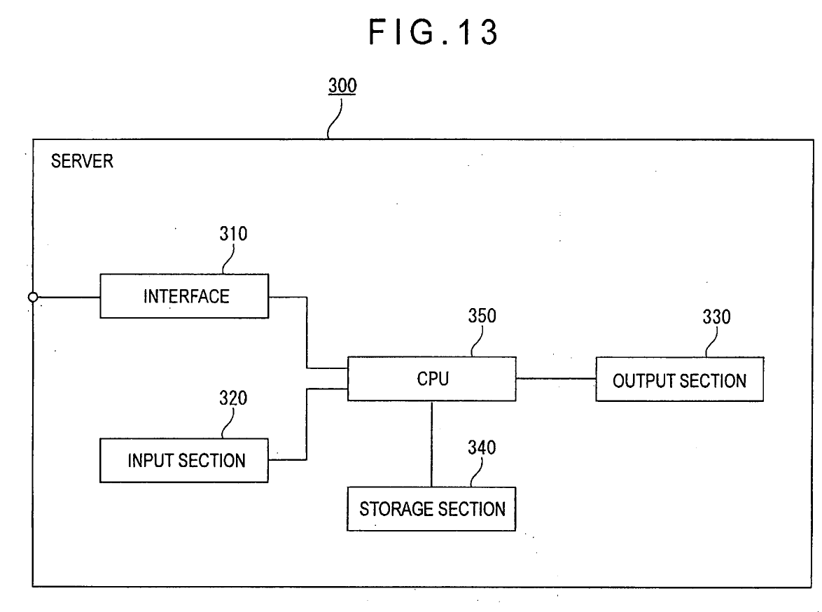

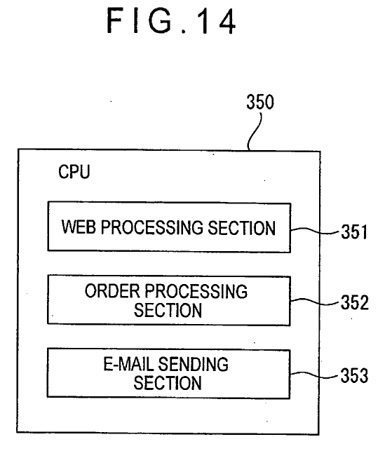

FIG. 9 is a schematic illustration showing an example of a web order management window displayed on the display section. FIG. 10 is a schematic illustration showing an example of a web top window at a time when a web file created by the information processing device is browsed on the display section. FIG. 11 is a schematic illustration showing an example of a web article description window that is displayed on the display section when an article is selected in FIG. 10. FIG. 12 is a schematic illustration showing an example of a web-article-purchase window that is displayed on the display section when a purchase of an article is selected in FIG. 11. FIG. 13 is a block diagram showing an outline of a server of the information processing system. FIG. 14 is a block diagram showing an outline of a server processing section of the server.

[Arrangement of Information Processing System]

Referring to FIG. 1, the reference numeral 100 denotes an information processing system. The information processing system 100 includes a network 110, an editing terminal 200 also functioning as an information processing device and an editing device and a server 300. The network 110 is connected to a plurality of terminals 400. In the information processing system 100, the editing terminal 200 creates a web file as content information that is written in a predetermined document description language such as the HTML (Hypertext Markup Language) and is browsable as a webpage (content), and then transmits the created web file to the server 300 via the network 110 so that the web file is browsable by a plurality of terminals 400. Note that in the present embodiment, although editing terminal 200 creates the web file by the HTML, the arrangement is not limited thereto, and the editing terminal 200 may create data with other languages such as a web language (e.g., XML (eXtensible Markup Language)) and an interpreted language (e.g., Perl (Practical Extraction and Report Language)).

(Arrangement of Editing Terminal)

The editing terminal 200 creates a web file that is written in the HTML for displaying a webpage for online shopping for selling and buying of an article on the Internet. Incidentally, although the present embodiment exemplifies the web file for the webpage of the online shopping, an arrangement for creating other web files such as a personal webpage may be employed. Also, without limiting to the web file written in the HTML, the web file written in other languages such as the XML may be created. While the editing terminal 200 of the present embodiment is a personal computer as an example, the editing terminal 200 may be a mobile device such as a mobile phone, a car navigation device, a video device and the like. The editing terminal 200 includes, as shown in FIG. 2, a communicator 210, an input unit (operating section) 220, a display section (display unit) 230, a sound output section 240, a storage section 250, a memory 260, a processor 270 and the like.

The communicator 210 is connected to the server 300 and the terminal 400 via the network 110 so as to be capable of communicating therewith. The communicator 210 is connected to the processor 270 such that the communicator 210 acquires various information such as a web file, image information and sound information from the server 300 via the network 110 under the control of the processor 270. The communicator 210 outputs the acquired various information to the processor 270. The network 110 may be the Internet based on a general-purpose protocol such as TCP/IP protocol, an intranet, a LAN (Local Area Network), or a communication network such as a phone line.

The input unit 220, which may be a keyboard or a mouse, has various operation buttons and operation knobs (each not shown) used for input operation. The operation buttons and the operation knobs are used to input settings such as setting of operation of the editing terminal 200, setting of information stored in the editing terminal 200 and update of information stored in the editing terminal 200. By the input operation of the settings, the input unit 220 outputs signals corresponding to the settings to the processor 270 to apply the settings. The input operation may be made by any arrangement for inputting various settings, without limiting to operations of the operation button and the operation knob, which may be made, for instance, by a touch panel provided on the display section 230 or by voice.

The display section 230 displays a signal representing image information input from the processor 270 on a display area (not shown) under the control of the processor 270. The image information may be those representing an image that is converted from the web file acquired from the server, those read from the storage section 250 and the memory 260, TV image information received by a TV receiver (not shown), those stored in an external device or a recording medium such as an optical disc, a magnetic disc and a memory card and read by a drive or a driver, and the like. The display section 230 may be a liquid crystal panel, an organic EL (Electro Luminescence) panel, a PDP (Plasma Display Panel), a CRT (Cathode-Ray Tube), an FED (Field Emission Display) and an electrophoretic display panel.

The sound output section 240 is provided with a sound generator such as a speaker (not shown). The sound output section 240, under the control of the processor 270, outputs various signals representing sound information sent from the processor 270 from the sound generator as a sound. The sound output section 240 may also output TV sound information received by a TV receiver, sound information stored in a recording medium, a storage section 250 and a memory 260, and the like.

The storage section 250 readably stores a template table 10 as shown in FIG. 3, a module table 20 as shown in FIG. 4, web files (not shown), image information and sound information linked with the web files (not shown), order information (not shown), customer information (not shown), transferring-direction setting information (not shown) and the like. The storage section 250 includes, although each not shown, a template storage area for storing the template table 10, a module storage area for storing the module table 20, a file storage area for storing the web files, the image information and the sound information, an order information storage area for storing the order information, a customer information storage area for storing the customer information, a transferring-direction information storing area for storing the transferring-direction setting information, and the like. Incidentally, although the storage section 250 includes six storage areas, the storage section 250 may not include any of the above-described storage areas or may include additional storage areas. Also, the storage section 250 may include a drive or a driver that can readably store data in a recording medium such as an HD (Hard Disk), a DVD (Digital Versatile Disc), an optical disc and a memory card.

Herein, the template table 10 is information about a layout of a web file which is used when the web file is created by the processor 270. As shown in FIG. 3, the template table 10 has a table structure containing plural pieces of template information 11, the template information each formed as a single data structure including and associated with template ID information 12, template name information 13, template category information 14, template property information 15 and layout information 16.

The template ID information 12 is specific information assigned to each piece of the template information 11 to identify the template information 11.

The template name information 13 is information about a name of the template information 11 that is identified by the template ID information 12. The template name information 13 contains a name of a template such as “top page” and “category list page” that is described in a text format. The template name contained in the template name information 13 may be arbitrarily determined by the input operation of the user or may be preset.

The template category information 14 is information about a category of the template information 11 that is identified by the template ID information 12. The template category information 14 contains a category of the template information 11 such as “shop page template” and “software sales template” that is described in a text format. Pieces of the template information 11 having common template category information 14 out of the plural pieces of template information 11 stored in the template table 10 are associated with each other so as to be categorized.

The template property information 15 is property information of the template information 11 identified by the template ID information 12, which may be overall settings, characteristics and the like of the template information 11. For instance, the template property information 15 may contain: information about placement position (i.e., right adjust, left adjust or center alignment) of each of later-described module information (content information) 21 placed in the web file when the web file is created by the processor 270 based on the template information 11; placement interval between each of the module information 21; top, bottom, right and left margin sizes around each of the module information 21 to be placed; a total width; and a column width. The template property information 15 may also contain an update date of the template information 11, the latest reference date of the template information 11, information about a creator of the template information 11 and the like. The template property information 15 may further contain: details of a header tag used in creating the web file, namely a title to be displayed when the web file is browsed using a web display program such as client software for web browsing; a format of a text to be displayed; and the like.

The layout information 16 is information about placement of each of the module information 21 in the template information 11 identified by the template ID information 12. The layout information 16 has a table structure containing plural pieces of placement position information 17, the placement position information 17 each formed as a single data structure including and associated with placement ID information 17A, placement position coordinate information (position coordinate information) 17B and placement module information (embedding frame information) 17C.

The placement ID information 17A is specific information assigned to each piece of the placement position information 17 to identify the placement position information 17.

The placement position coordinate information 17B is information about a placement coordinate of the placement position information 17 that is identified by the placement ID information 17A. The placement position coordinate information 17B may contain, for instance, coordinates of a left-top corner point and a right-bottom corner point of a position to place the module information 21, where a left-top corner point of the web file to be created based on the template information 11 is provided as an origin point.

The placement module information 17C is information about the module information 21 to be placed at the coordinate position represented by the placement position coordinate information 17B of the placement position information 17 that is identified by the placement ID information 17A The placement module information 17C contains information associated with module ID information 22 of the later-described module information 21. When the web file is created by the processor 270, the placement module information 17C and the associated module information 21 are embedded in the coordinate position that is specified by the placement position coordinate information 17B. Incidentally, the placement module information 17C may contain information for being associated with plural pieces of module information 21. In such case, module details information 25 corresponding to the plural pieces of module information 21 is embedded in a layout frame 34A of the web file to be created.

The module table 20 contains information constituting elements of the web file when the web file is created by the processor 270. As shown in FIG. 4, the module table 20 has a table structure containing plural pieces of module information 21, the module information 21 each formed as a single data structure including and associated with module ID information 22, module name information 23, module category information 24, module details information 25, and module property information 26.

The module ID information 21 is specific information assigned to each piece of the module ID information 22 to identify the module information 21. The module ID information 22 is associated with the placement module information 17C of the template information 11 as described above. The module information 21 identified by the module ID information 22 is associated with each of the template information 11 having the placement module information 17C associated with this module ID information 22.

The module name information 23 is information about a name of the module information 21 that is identified by the module ID information 22. The module name information 23 contains a name of the module information 21 such as “header”, “footer”, “main menu” and “category navigation” described in a text format.

The module category information 24 is information about a category of the module information 21 that is identified by the module ID information 22. The module category information 24 contains a category of the module information 21 such as “header”, “main menu”, “link” and “recommended article” described in a text format. Pieces of the module information 21 having common module category information 24 in the plural pieces of module information 21 stored in the module table 20 are associated with each other so as to be categorized.

The module details information 25 is information about details of the module information 21 that is identified by the module ID information 22. The module details information 25 contains information about details to be displayed on the display section 230 as a part of the webpage. Specifically, the module details information 25 contains, for instance, information containing characters in text format, image information, sound information and link information to the image information, the sound information and another web file. The module details information 25 may also contain the web file that is described in the HTML format.

The module property information 26 is property information of the module information 21 identified by the module ID information 22, which may be overall settings, characteristics and the like of the module information 21. For instance, the module property information 26 may contain information about placement position (i.e., right adjust, left adjust or center alignment) of information contained in the module details information 25, an update date of the module information 21, the latest reference date of the module information 21, information about a creator of the module information 21.

The order information (not shown) stored in the order information storage area of the storage section 250 is constructed as a single data structure associated with order number information containing a specific ID for identifying the order information, order date information about a date when an article is ordered, orderer information containing individual information of an orderer such as a name, an address, an e-mail address, a contact address, etc of the orderer, ordered-article information about the ordered article, shipping address information about an address to which the ordered article is shipped, e-mail transmission record information containing a record of e-mails, order status information about payment status and shipment status of the ordered article, and the like.

The customer information (not shown) stored in the customer information storage area of the storage section 250 is information about, for instance, the orderer information and the shipping address information of the order information, which contains individual information of a customer such as name, an address and a contact address.

The transferring-direction setting information (not shown) stored in the transferring direction information storage area of the storage section 250 contains plural pieces of server information about the server 300 that can browse the web file on the network. The server information is constructed as a single data structure associated with, for instance, server name information, address information, server user information and initial directory information. The server name information is information about a name of the server 300 as the transferring direction. The address information is information about an IP address, a domain address or the like as network information of the server 300. The server user information is information about an authentication ID and an authentication password required for accessing the server 300 via the network. The initial directory information is information representing a point to access first after the access to the server 300, e.g., a point from a root directory.

The memory 260 readably stores the settings that are input at the input unit 220, the sound information, the image information and the like. The memory 260 readably stores various programs and the like that are run on an OS (Operating System) for entirely controlling the editing terminal 200. Also, the memory 260 may include a drive or a driver that can readably store the data in a recording medium such as an HD, DVD and optical disc.

The processor 270 includes various input/output ports (not shown) such as a communication port connected to the communicator 210, a key input port connected to the input unit 220, a display port connected to the display section 230, a sound port connected to the sound output section 240, a storage port connected to the storage section 250, a memory port connected to the memory 260, and the like. As shown in FIG. 5, the processor 270 includes, as various programs, an information recognizer 271 also functioning as a details information recognizer and a template recognizer, a webpage reader 272, a display controller 273, a template editor 274 also functioning as an information associator and a template recognizer, a module editor 275 as a details information editor, a file creating section 276 as an information generator, a file transferer 277, and the like.

The information recognizer 271 refers to an input signal input by the user's input operation at the input unit 220 and recognizes various setting information based on the input signal. Here, the various setting information may include, for instance, web-file-creation request information for creating a web file, template editing information about an editing details of the template information 11, module editing information about an editing details of the module information 21, file-transfer request information for transferring the web file and other various information to the server 300, download request information for transferring the web file an the other various information from the server to the editing terminal 200, display request information for displaying predetermined image information on the display section 230, sound request information for outputting predetermined sound information from the sound output section 240 and setting information about other settings.

When the information recognizer 271 refers to the input signal input by the user's input operation at the input unit 220 and recognizes the web-file-creation request information for creating the web file in the input signal, the information recognizer 271 reads predetermined template information 11 from the template table 10 stored in the template storage area of the storage section 250. The information recognizer 271 further reads predetermined module information 21 from the module table 20 stored in the module storage area of the storage section 250.

The webpage reader 272 reads the web file written in the HTML and decodes it to image information that is displayable in the display area of the display section 230. Specifically, when the information recognizer 271 recognizes request information for displaying a predetermined web file in the various setting information, which is input by the user's input operation, the webpage reader 272 reads the predetermined web file. Then, the webpage reader 272 decrypts predetermined instruction tag information in the read web file, decrypts the web file so as to be displayable in a display format according to the instruction tag information, and decodes the read web file into the image information that is displayable on the display section 230. The web reader may utilize client software such as Internet Explorer (IE, registered trademark of Microsoft Corporation) and Netscape Navigator (registered trademark of Netscape Communications Corporation).

The display controller 273 controls to display the image information, the web file, a web file creation window and the like in the display area of the display section 230 in accordance with the various setting information recognized by the information recognizer 271. Specifically, when the information recognizer 271 recognizes the web-file-creation request information or web-file-editing request information for editing the web file, the display controller 273 controls the display section 230 to display a template editing window 30 as shown in FIG. 6 in the display area. When the information recognizer 271 recognizes information for editing the module information 21, the display controller 273 controls the display section 230 to display a module editing window 40 as shown in FIG. 7 in the display area. When the information recognizer 271 recognizes request information for viewing a preview of the web file being created in the various setting information, the display controller 273 controls the display section 230 to display a preview window 50 as shown in FIG. 8 in the display area. When the information recognizer 271 recognizes request information for browsing downloaded order information in the various setting information, the display controller 273 controls the display section 230 to display a web order management window 60 as shown in FIG. 9 in the display area. Then, when the information recognizer 271 recognizes request information for displaying a predetermined web file in the various setting information, the display controller 273 controls to decrypt, for instance, the HTML of the webpage as an object to be displayed to convert it into the displayable image information and controls the display section 230 to display a web top window 70 as shown in FIG. 10, a web article description window 80 as shown in FIG. 11 and a web article description window 90 as shown in FIG. 12.

As shown in FIG. 6, the template editing window 30 has a window configuration in which a window is divided into three zones in a horizontal direction and command buttons 31 are arranged on the upper part of the window. A left zone of the divided three zones of the window of the template editing window 30 displays a list section 32 as a template listing image, a center zone displays a center display section 34 as a template display window and a right zone displays a module list section 36 as a module listing image. Widths of the list section 32, the center display section 34 and the module list section 36, which are the three zones divided from the template editing window 30, may be arbitrarily varied.

The command buttons 31 represent computing operation to be performed by the processor 270. The command buttons 31 includes various buttons such as a start button 31A, a PC design button 31B, a mobile design button 31C, an article management button 31D, an order management button 31E, a customer management button 31F, a shop setting button 31G, an e-mail editing button 31H, an update button 31I, a file transfer button 31J, a download button 31K and an open button 31L, the various buttons being aligned, for instance, in a horizontal direction. The start button 31A represents information for creating a web file based on the template information 11 and the module information 21. The PC design button 31B represents PC page switch information for switching display to a creation mode of the webpage that is browsable on a personal computer. The mobile design button 31C represents PC mobile page switch information for switching into a creation mode of the webpage that is browsable on mobile equipment such as a mobile phone. The article management button 31D represents article display information for displaying detailed information about an article displayed on the webpage. The order management button 31E represents order browsing information for browsing order information downloaded from the server 300. The customer management button 31F represents customer display information for displaying customer information of customer information table. The shop setting button 31G represents webpage editing information for editing detailed description of the webpage. The e-mail editing button 31H represents automatic-response e-mail editing information for editing details of an e-mail that is automatically replied to a customer when the customer browsing the web file transferred from the server 300 sends an e-mail from the webpage corresponding to the browsed web file to the editing terminal 200 or to a predetermined e-mail address. The update button 31I represents update information for reflecting the edited result. The file transfer button 31J represents transfer information for transferring the created web file to the server 300. The download button 31K represents download information for acquiring various information stored in the server 300 and the order information. The open button 31L represents web browsing information for browsing the created web file by predetermined client software.

The list section 32 displays a template listing section 32A arranged vertically. The template listing section 32A is provided with a template-category display section 32B on an upper part thereof. The template-category display section 32B displays a category name contained in the template category information 14 of the template information 11.

Template names 32C are arranged below the template-category display section 32B of the template listing section 32A, the template names 32C vertically listed in lines. These template names 32C are displayed by extracting name of templates contained in the template name information 13 of the template information 11 having common template category information 14 as category names contained in the template-category display section 32B. Template icons 32D are displayed on the left sides of the template names 32C. These template icons 32D can be set arbitrarily by the user's input operation. Positions of the template names 32C and the template icons 32D are not particularly limited, which may be arranged in a horizontal direction or in a vertical direction. A template listing section 32A displays cursor information 33 for selecting any one of the template names 32C and the template icons 32D that are vertically arranged.

A template-operation display section 32E is displayed above the template listing section 32A. The template-operation display section 32E displays, for instance, a new creation button for adding a new piece of template information 11, a template copy button for copying the template information 11 corresponding to a template name 32C enclosed by the cursor information 33 in the template information 11 that have been already created, a template delete button for deleting the template information 11 corresponding to the template name 32C enclosed by the cursor information 33 in the template information 11 that have been already created.

Tab information 32F is displayed on an upper end of the list section 32 to switch between the list section 32 and the list section 32 (FIG. 8) as an object to be displayed on the left zone of the three divided zones of the template editing window 30.

The center display section 34 displays a layout of the template information 11 corresponding to the template name 32C enclosed by the cursor information 33 of the list section 32. Layout frames 34A as information embedding frames are arranged substantially at the center of the center display section 34 based on the layout information 16 of the template information 11 corresponding to the template name 32C enclosed by the cursor information 33 of the list section 32. The layout frames 34A are placed and displayed at coordinate positions corresponding to the placement position coordinate information 17B of each of the placement position information 17 contained in the layout information 16 of the template information 11.

The layout frame 34A displays module names 34B arranged vertically. The module name 34B displays a name of the module information 21 contained in the module name information 23 of the module information 21 that is associated with the placement module information 17C, based on the placement module information 17C of the placement position information 17. The module names 34B are displayed with background colors different from each other. A layout cursor 35 is displayed on one of the module names 34B for selecting the module information 21 corresponding to the module name 34B.

Screen configuration information 34C is displayed below the layout frame 34A of the center display section 34. The screen configuration information 34C displays an entire display position and top, bottom, right and left margin sizes of the web file to be created, interval between the layout frames 34A, the total width and widths of small columns of the layout frames 34A and the like, based on the template property information 15 of the template information 11.

A template-name display section 34D is arranged above the layout frames 34A of the center display section 34, in which a template name of the template information 11 displayed in the center display section 34 is displayed. A module-placement deleting button 34E is arranged below the template-name display section 34D for deleting the module information 21 selected by the layout cursor 35 from the layout frame 34A. A layout change button 34F is displayed on the right side of the module-placement deleting button 34E for changing the layout information 16 of the template information 11. Tab information 34G is displayed at a lower end of the center display section 34 for displaying the template property information 15 of the template information 11 corresponding to the template name 32C selected by the cursor information 33 in the list section 32.

A module listing area 36A is arranged vertically in the module list section 36. Module-category display sections 36B are arranged vertically and in parallel in the module listing area 36A. The module-category display section displays module category names of the module category information 24 based on the module category information 24 of the module information 21 in the module table 20. Module-name display sections 36C are arranged below one of the module-category display sections 36B, the module-name display sections 36C vertically listed in lines. The module-name display section 36C displays the name of the module information 21 based on the module name information 23 of the module information 21. A module icon 36D is displayed on the left end of the module-name display section 36C. A module cursor 37 for selecting any one of the module-name display sections 36C by enclosing the module-name display section 36C and the module icon 36D.

A module operation display section 36E is displayed above the module listing area 36A. The module operation display section 36E displays, for instance, a new creation button for adding a new piece of module information 21, a module copy button for copying the module information 21 corresponding to the module-name display section 36C enclosed by the module cursor 37 out of the module information 21 that have been already created, a module deleting button for deleting the module information 21 corresponding to the module-name display section 36C enclosed by the module cursor 37 out of the module information 21 that have been already created, the module editing button for editing the module information 21 corresponding to the module-name display section 36C enclosed by the module cursor 37 in the module information 21 that have been already created.

The module editing window 40 has a window configuration with a module editing area 41 arranged substantially at the center thereof. The module editing area 41 displays editing-details information edited by the user's input operation. A module-editing command button 42 is arranged above the module editing area 41. Examples of the module-editing command button 42 may include, for instance, a link button for providing link information at a predetermined position, a table-insertion button for inserting a table in a predetermined position, an image-insertion button for inserting image information at a predetermined position and an undo button for changing editing details of the module editing area 41 to the previous editing status.

A module-name display field 43 is arranged above the module editing command button. The module-name display field displays a name of a module contained in the module name information 23 of the module information 21 that is currently being edited.

A switch tab button 44 is displayed on the lower end of the module editing area 41 of the module editing window 40 for switching between an editing mode, an HTML display mode and a preview mode. In FIG. 7, since the switch tab button 44 is switched to “edit” mode, the module editing area 41 displays, for instance, an input cursor 41A and an input-area display frame 41B as shown in FIG. 7. When the switch tab button 44 is switched to “HTML” mode, although not shown, the module editing area 41 displays the web file written in the HTML. When the switch tab button 44 is switched to “preview” mode, a web preview window is displayed in a browsable state that is converted from the module details information 25 of the module information 21 written in the HTML by the webpage reader 272.

Displayed on the right side of the switch tab button are an OK button 45 for applying the editing of the module and completing the editing, a cancellation button 46 for completing the editing without applying the editing of the module, and a help button 47 for browsing a supplemental description document about the editing of the module.

As shown in FIG. 8, the preview window 50 has a window configuration in which a window is divided into three zones in a horizontal direction and the command buttons 31 same as those in the template editing window 30 are arranged on the upper part of the window. As with the template editing window, a left zone of the three divided zones of the preview window 50 displays the list section 32, a center zone displays the center display section 34 and a right zone displays a module list section 36.

In the preview window 50, the list section 32 displays a site map 51 that shows relevance between web files created by the file creating section (described later) 276 of the processor 270. The site map 51 hierarchically displays the web files mutually associated with each other by link information or the like contained in the web files, and file names of the mutually associated web files are connected with, for instance, a line. Tab information 32F is displayed on an upper end of the list section 32 for switching the display of the list section 32 between the template listing section 32A and the site map 51. Web selection information 52 is displayed for highlighting any one of the file names of the web files displayed in the site map 51 for selecting a web file corresponding to the highlighted file name. The web selection information 52 may be highlighted by inverting a color of texts of the file name and a background color or by enclosing the selected file name with a frame.

The center display section 34 of the preview window 50 displays preview information 53 (content display image) as a preview of the web file corresponding to the file name selected by the web selection information 52. The preview information 53 displays image information that is prepared by decoding the HTML of the web file as an object to be read by the webpage reader 272 into the browsable state.

As shown in FIG. 9, the web order management window 60 has a window configuration in which a window is divided into two zones in a horizontal direction and the command buttons 31 same as those in the template editing window 30 and the preview window 50 are arranged on the upper part of the window. When recognizing that the order management button 31E of the command buttons 31 is selected by, for instance, clicking with the input unit 220, the display is switched from the template editing window 30 or the preview window 50 under the control of the display controller 273 to display the web order management window 60.

An order-status selection display section 61 is arranged on a left zone of the divided window of the web order management window 60. As shown in FIG. 9, the order-status selection display section 61 displays order-status display information 61A about an order status of an order of the order information such as “all orders”, “new order”, “unpaid/unshipped”, “paid/unshipped”, “shipped/unpaid”, “transaction completed”, “canceled” and the like, the order-status display information 61A vertically listed in lines. Also, order-status selection information 61B encloses any one of the order-status display information 61A for selection. The order-status selection information 61B may have arrangements in which: a text color and a background color are inverted as shown in FIG. 9; the selected order-status display information 61A is displayed in the text color different from those of other order-status display information 61A; a mark or an icon for indicating selection of the order-status display information 61A is displayed at, for instance, a left end of the selected order-status display information 61A; and the like.

An order listing section 62 is arranged on an upper part of a right zone of the divided window of the web order management window 60. The order listing section 62 displays order display sections 62A corresponding to the order-status display information 61A selected by the order-status selection information 61B, the order display sections 62A aligned vertically. The order display section 62A displays, from the left end thereof, an order number, a reception date, a family name, a first name, a prefecture, a customer rank, an ordered article name, an article price, an order status and the like based on the order number information, the order date information, the orderer information, the ordered-article information and the like of the order information. Order selection information 62B is displayed in a manner enclosing any one of the order display section 62A. The order selection information 62B may have arrangements in which: a text color and a background color are inverted; the selected order display section 62A is displayed in the text color different from those of other order display sections 62A; a mark or an icon for indicating selection of the order display section 62A is displayed at, for instance, a left end of the selected order display section 62A; and the like. Order management commands 62C are displayed above the order listing section 62. The order management command 62C is a button for editing the order information corresponding to the order display section 62A selected by the order selection information 62B. The order management command 62C may include, as shown in FIG. 9 for instance, a new-order creation button for creating a new piece of order information, an order deleting button for deleting the order information corresponding to the order display section 62A selected by the order selection information 62B, a detailed-display button for displaying in detail the order information corresponding to the order display section 62A selected by the order selection information 62B, a retrieval button for retrieving order information that meets a predetermined requirement from the plurality of order information, a print button for printing the order information corresponding to the order display section 62A selected by the order selection information 62B in a predetermined format, an output button for describing order information corresponding to the order display sections 62A displayed in the order listing section 62 in a predetermined file format such as the CSV (Comma Separated Values) format, a status change button for changing the order status information of the order information corresponding to the order display section 62A selected by the order selection information 62B, an e-mail sending button for sending an e-mail to an e-mail address contained in the orderer information of the order information corresponding to the order display section 62A selected by the order selection information 62B, a sort button for sorting the order information corresponding to the order display section 62A selected by the order selection information 62B into another order-status display information 61A.

An order details display section 63 is arranged below the order listing section 62 of the web order management window 60. The order details display section 63 displays detailed information of the order information corresponding to the order display section 62A selected by the order selection information 62B in the order listing section 62. Order numbers 63A based on the order number information are displayed on the upper part of the order details display section 63, and order statuses 63B such as the payment status and the shipment status are displayed below the order number 63A based on the order status information. A reception date based on the order date information is displayed on the upper part of the order details display section 63.

A details window 63C is arranged on the lower portion of the order details display section 63, and details item switch tabs 63D are arranged on the upper end of the details window 63C. The details item switch tab 63D includes tabs including, for instance, items such as “article”, “orderer”, “shipping address”, “additional information”, “e-mail transmission record” and the like. When these tabs are switched by the user's input operation, information displayed in the details window 63C is switched accordingly. For instance, when “orderer” tab is selected in the details item switch tabs, the details window 63C displays, as shown in FIG. 9, information such as a name, an address, an e-mail address, a company name, etc. of the orderer based on the orderer information of the order information.

Referring back to FIG. 5, the template editor 274 of the processor 270 edits details of the template name information 13, the template category information 14, the template property information 15, the layout information 16 and the like of the template information 11. Specifically, when the information recognizer 271 refers to an input signal input by the user's input operation at the input unit 220 and recognizes information for changing the template name information in the input signal, i.e., recognizes that a text displayed in the template-name display section 34D of the center display section 34 in the template editing window 30 is changed, the template editor 274 changes the template name information 13 of the template information 11. Further, the information recognizer 271 recognizes that an input signal for changing the layout information 16, the template editor 274 accordingly changes the layout information 16. For instance, when the information recognizer 271 recognizes that a predetermined module icon 36D is moved from the module list section to a predetermined layout frame 34A by drag-and-drop using a mouse or the like, namely, when the information recognizer 271 recognizes an input signal for selecting module information 21 to be placed in predetermined placement module information 17C, the template editor 274 describes information for placing the module information 21 corresponding to the moved module icon 36D in the placement module information 17C of the placement position information 17. In other words, the template editor 274 associates the module information 21 corresponding to the moved module icon 36D with the template information 11 having the placement module information 17C to which the module information 21 is moved. Further, when recognizing, for instance, information for moving one side of a margin of the layout frame 34A, the template editor 274 changes a coordinate of the placement position coordinate information 17B of the placement position information 17 according to the movement amount. Then, the template editor 274 readably stores the edited template information 11 in the memory 260. When recognizing an input signal input by the user's input operation for applying the edited detail, the template editor 274 adds the edited template information 11 stored in the memory 260 to the template table 10 in the storage section 250 to update the template table 10. Note that, the template editor 274 may be so arranged that, when recognizing information for selecting a new button of the template-operation display section 32E in the input signal, the template editor 274 displays a sample of the template information having been prepared in advance in the center display section 34.

The module editor 275 recognizes an input signal input by the user's input operation at the input unit 220 and edits the module name information 23, the module category information 24, the module details information 25, the module property information 26 and the like of the module information 21. Specifically, for instance, in the module editing window 40 as shown in FIG. 7, when recognizing change request information for changing the details of the module editing area 41, the module editor 275 appropriately controls the display controller 273 to change the details displayed in the module editing area 41 in accordance with the change request information. Also, the module editor 275 changes the module details information 25 of the module information 21 in accordance with the change request information. When recognizing information for changing the module name information 23, the module category information 24 or the module details information 25 in a input signal input by the user's input operation at the input unit 220, the module editor 275 accordingly changes the module name information 23, the module category information 24 or the module details information 25 of the module information. Then, the module editor 275 readably stores the changed module information 21 in the memory 260. In addition, when recognizing information input by the user's input operation for applying the edited detail, the module editor 275 adds the module information 21 stored in the memory 260 to the module table 20 in the storage section 250 to update the module table 20.

The file creating section 276 generates a web file based on the template information 11 and the module information 21 each recognized by the information recognizer 271 and respectively edited by the template editor 274 and the module editor 275. Specifically, for instance, when recognizing that the start button 31A of the command buttons 31 is selected by clicking or the like, in the windows as shown in FIGS. 6, 8 and 9, the file creating section 276 recognizes pieces of template information 11 having common template category information 14. Then, the file creating section 276 recognizes the layout information 16 of each of those pieces of template information 11 to recognize the placement position coordinate information 17B and the placement module information 17C of the placement position information 17 contained in the layout information 16. The file creating section 276 then recognizes the module information 21 to be placed in each layout frame based on the placement module information 17C. The file creating section 276 constructs a web file that is capable of displaying the layout frame 34A using, for instance, a table tag based on the layout information 16 of the template information 11. Thereafter, the file creating section 276 places the information contained in the module details information 25 of the module information 21 in a predetermined position of the table tag of the layout frame 34A that is created in the HTML format, i.e., a language having predetermined command tag information, and embeds the module details information 25 in the layout frame 34A. Incidentally, when the module details information 25 is not created appropriately in the HTML format, the module details information 25 has to be converted into the HTML format before being placed in the table tag. The file creating section 276 performs the same processing for all the template information 11 having the common template category information 14 and creates at one time web files of the number corresponding to those template information 11 from the plural pieces of the template information 11 and the module information 21. Note that, the web file creating section 276 may control the display controller 273 to display the created web files in the preview window 50 as shown in FIG. 8 on the display section 230.

The file transferee 277 transmits the created web files to the server 300. Also, the file transferer 277 transfers or downloads a predetermined web file, order file or other files from the server 300 to the editing terminal 200. Specifically, when recognizing that the file transfer button 313 of the command buttons 31 is selected by clicking or the like, the file transferer 277 recognizes the transferring-direction setting information stored in the transferring direction information storage area in the storage section 250. Then, the file transferer 277 recognizes predetermined server information from the transferring-direction setting information by the user's input operation and accesses a predetermined server 300 based on the address information contained in the server information via the network 110. Thereafter, the file transferer 277 transfers the web file to a predetermined directory of the server 300 based on the server information. Specifically, when recognizing that the download button 31K of the command buttons 31 is selected by clicking or the like, the file transferer 277 recognizes the transferring-direction setting information stored in the transferring direction information storage area in the storage section 250. Then, the file transferer 277 recognizes the predetermined server information from the transferring direction setting information by the user's input operation and accesses the predetermined server 300 based on the address information contained in the server information via the network 110. Then, the file transferer 277 downloads the order information contained in the predetermined directory of the server 300 and stores the order information in the order information storage area in the storage section 250. Further, when recognizing that there is request information for acquiring a predetermined web file in an input signal input by the user's input operation at the input unit 220, the file transferer 277 downloads the predetermined web file to the server 300 and stored it in the storage section 250.

The order operating section 278, when recognizing that the order management button 31E of the command buttons 31 is selected by clicking or the like, controls the display controller 273 to display the web order management window 60 as shown in FIG. 8. Then, when the user operates the order management command 62C by clicking or the like in the order management window, the order operating section 278 edits or deletes the order information according to the input signal resulted from the operation. Specifically, when recognizing information for changing the order status input by the user's input operation at the input unit 220, the order operating section 278 changes the order status information of the order information. Similarly, when recognizing information for deleting the order information, the order operating section 278 deletes the order information.

(Arrangement of Server)

The server 300 includes, as shown in FIG. 13, an interface 310, an input section 320, an output section 330, a storage section 340 and a CPU 350.

The interface 310 is connected to the editing terminal 200 and the terminal 400 via the network 110, while being connected to the CPU 350. The interface 310 performs preset input interface processing over a server signal input via the network 110 and outputs it as a processing server signal to the CPU 350. When the processing server signal to be transmitted to the editing terminal 200 or the terminal 400 is input from the CPU 350, the interface 310 performs preset output interface processing over the input processing server signal to output it as a server signal to the editing terminal 200 or a predetermined terminal 400 via the network 110.

The input section 320, which may be a keyboard or a mouse, has various operation buttons and operation knobs (each not shown) used for input operation. The operation buttons and the operation knobs are used for input operations of settings such as setting of operation of the server 300, setting of information to be stored in the storage section 340 and update of information stored in the storage section 340. By the input operation of the settings, the input section 320 outputs signals corresponding to the settings to the CPU 350 to apply the settings. The input operation may be made by any arrangement for inputting various settings without limiting to operations of the operation button and the operation knob, which may be made, for instance, by a touch panel provided on the output section 330 or by voice.

The output section 330 displays image data sent from the CPU 350, under the control of the CPU 350. The output section 330, like the display section 230 of the editing terminal 200, may be a liquid crystal panel, an organic EL panel, a PDP, a CRT, an FED and an electrophoretic display panel. Examples of the image data to be displayed on the output section 330 may include those sent from the storage section 340 and those acquired from external servers via the network 110.

The storage section 340 includes: a web storage area (not shown) for readably storing various information and web files received from the editing terminal 200, the terminal 400 or the external servers; and order storage area (not shown) for readably storing the order information (not shown) received from the terminal 400. The storage 340 may include a drive or a driver that can readably store the data in a recording medium such as an HD, a DVD, an optical disc and a memory card. Information input by the input operation at the input section 320 may also be stored in the storage section 340, the details of which can be appropriately updated by the input operation. The storage section 340 also stores various programs and the like that are run on an OS (Operating System) for entirely controlling the server 300.

The CPU 350 includes a web processing section 351, an order processing section 352, an e-mail sending section 353 and the like as the various programs stored in the storage section 340. The web processing section 351 is a program for operating the server 300 to function as a web server. The web processing section 351 transmits a predetermined web file out of the web files transmitted from the editing terminal 200 and stored in the storage section 340 in accordance with web-file browsing request information from the webpage reader 272 of the editing terminal 200 or the client software of the terminal 400. The web processing section 351 executes a predetermine program such as CGI (Common Gateway Interface) program, SSI (Server Side Include) program, Java (a program language developed by Sun Microsystems, Inc.) in accordance with request information from the editing terminal 200 or a predetermined terminal 400, and sends execution result respectively to the editing terminal 200 or the predetermined terminal 400.

The order processing section 352 recognizes predetermined order information transmitted from the terminal 400 and stores the order information in the order storage area in the storage section 340 together with IP information or the like for identifying the terminal 400 that transmits the order information. The order processing section 352, when recognizing request information from the editing terminal 200 for requesting download of the order information, transmits the order information stored in the order storage area of the storage section 340 to the editing terminal 200.

The e-mail sending section 353, in response to the order information transmitted from the terminal 400, transmits information indicating reception of new order information to the editing terminal 200 by an e-mail to notify the user of the reception of the order. Incidentally, the e-mail sending section 353 may automatically transmits to the terminal 400 that has transmitted the order information a preset sentence, e.g., “Thank you for shopping with us”.

(Arrangement of Terminal)

The terminal 400 is connected to the editing terminal 200 and the server 300 via the network 110. The terminal 400 may be a personal computer, a mobile phone, a television device, a video device, a navigation device and the like that is capable of communicating via the network. The terminal 400 includes, although not shown, a transmitter/receiver, a terminal display section, a storage unit, an input operation section, a processing unit or and the like. The transmitter/receiver is connected to the server 300 via the network 110 so as to be capable of communicating therewith in order to transmit and receive various information, web files and the like. The terminal display displays the web windows as shown in FIGS. 10 to 12 on a display area (not shown). The input operation section, based on input operation of an orderer who operates the terminal 400, inputs an input signal corresponding to the input operation to the processing unit. The input operation section may be, like the input unit 220 of the editing terminal 200, a mouse, a keyboard, etc. The storage unit stores the web files received from the server 300 and other various information. The storage unit also stores various programs such as web-browsing client software for processing the web file into a browsable state. The processing unit runs the programs such as the web-browsing client software and performs a predetermined computation.

[Operation of Information Processing System]

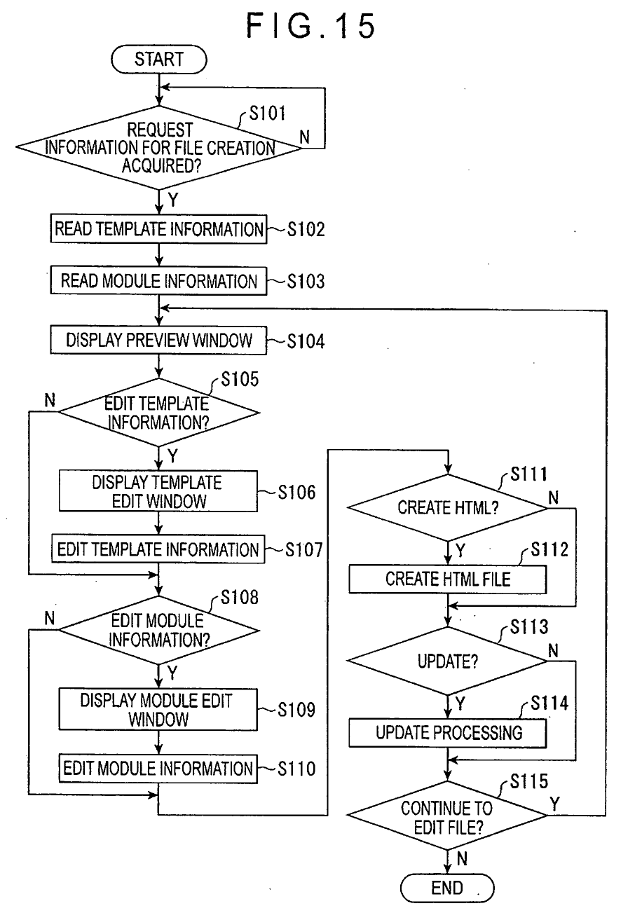

Next, referring to FIG. 15, web-file creation processing as an operation of the information processing system will be described. FIG. 15 is a flowchart showing web-file creation processing.

In FIG. 15, the processor 270 of the editing terminal 200 of the information processing system 100 operates the information recognizer 271 to recognize an input signal input by the user's input operation at the input unit 220. Then, the processor 270 determines whether or not the input signal contains information for creating a web file (Step S101).

In Step S101, when recognizing the information for creating the web file with the information recognizer 271, the processor 270 controls the display controller 273 to display in a display area of the output section 330 guidance information for asking whether the user desires to create a web file newly or to create a web file using the existing template information 11. Then, when the processor 270 recognizes that information for editing the existing web file is set by the user's input operation at the input unit 220, the processor 270 operates the information recognizer 271 to read predetermined template information 11 corresponding to the existing web file selected by the user's input operation from the template table 10 stored in the template storage area in the storage section 250. At this time, the information recognizer 271 recognizes the template category information 14 of the template information 11 corresponding to the web file selected by the user's input operation, and reads all the template information 11 that has common template category information 14 (Step S102). On the other hand, when the processor 270 recognizes that the information for newly creating a web file is set by the user's input operation at the input unit 220, the processor 270 displays guidance information on the display section 230 for further asking whether or not the user desires to use a sample template. Then, when recognizing setting for using the sample template, the processor 270 reads sample template information 11 stored in the template table 10 of the storage section 250. On the other hand, when recognizing setting for not using the sample template, the processor 270 creates new template information 11.

The processor 270 reads module information 21 associated with the template information 11 read in Step S102 from the module table 20 stored in the module storage area in the storage section 250 (Step S103).

Based on the template information 11 and the module information 21 read in Steps S102 and S103, the processor 270 operates the display controller 273 to perform control so as to display the preview window 50 as shown in FIG. 8 (Step S104). The processor 270 makes the web file recognized at the time of reading the template information 11 browsable by the webpage reader 272 and operates the display controller 273 to display the preview window 50 on the display section 230.

Next, when the information recognizer 271 of the processor 270 recognizes that a PC design button 31B or a mobile design button 31C is selected in the preview window 50 as shown in FIG. 8 by the user's input operation at the input unit 220, e.g., by clicking of a mouse (Step S105), the processor 270 operates the display controller 273 to display the template editing window 30 as shown in FIG. 6 in the display area of the display section 230 (Step S106).

Then, the processor 270 appropriately controls the template editor 274 to edit the template information 11 based on the input signal input by the user's input operation at the input unit 220 (Step S107). When recognizing information input by the user's input operation at the input unit 220 for applying the edited template information 11, the processor 270 stores the edited template information 11 in the template table 10 stored in the template storage area in the storage section 250.

Specifically, as an example, in the template editing window 30 as shown in FIG. 6, when the information recognizer 271 recognizes information input by the user's input operation at the input unit 220 for changing a template name displayed in the template-name display section 34D, the template editor 274 changes the template name information 13 of the template information 11 to the changed template name. When, as another example, the information recognizer 271 recognizes information input by the user's input operation at the input unit 220 for moving the module-name display section 36C displayed in the module list section 36 to a layout frame 34A, the template editor 274 associates the placement module information 17C of the placement position information 17 having the placement position coordinate information 17B corresponding to the layout frame 34A with the module information 21 corresponding to the moved module-name display section 36C, so that the template information 11 and the module information 21 are associated. As still another example, when the information recognizer 271 recognizes information input by the user's input operation at the input unit 220 for indicating that the module-placement deleting button 34E has been selected, the template editor 274 deletes association between the placement module information 17C of the template information 11 and the module information 21 selected by the layout cursor 35. As further example, when the information recognizer 271 recognizes information input by the user's input operation at the input unit 220 for indicating that the layout change button 34F has been selected, the template editor 274 displays guidance information for changing the placement position coordinate information 17B of the template information 11 on the display section 230. As further example, when the information recognizer 271 recognizes information input by the user's input operation at the input unit 220 for changing the size such as the width of the layout frame 34A, the placement position of the layout frame 34A or the number of the layout frames 34A, the template editor 274 changes the placement position coordinate information 17B of the template information 11 accordingly. Then, the template editor 274 readably stores the template information 11 edited as described above in the memory 260. Further, when the information recognizer 271 recognizes information for applying the edited template information 11, the template editor 274 stores the edited template information in the template table 10 stored in the storage section 250, so that the template table 10 is updated.

After Step S107, or when the information for not editing the template information 11 is recognized by the information recognizer 271 in Step S105, the processor 270 determines whether or not to edit the module information 21 (Step S108). Here, the processor 270 determines whether or not a module editing button in the module operation display section 36E is selected by the user's input operation in the template editing window 30 or the preview window 50.

Then, when the processor 270 determines to edit the module information in Step S108, the display controller 273 controls the display section 230 to display the module editing window 40 as shown in FIG. 7 in the display area of the display section 230 (Step S109).

In Step S109, when the information recognizer 271 recognizes that the details of the module details information 25 displayed in the module editing area has been changed by the user's input operation at the input unit 220, the processor 270 operates the module editor 275 to change the module details information 25 so as to have the changed details (Step S110).

When the information recognizer 271 recognizes information indicating that the OK button 45 is selected, the module editor 275 readably stores the edited module information 21 in the memory 260. Further, when the information recognizer 271 recognizes information for applying the edited module information 21, the module editor 275 stores the edited module information 21 stored in the memory 260 in the module table 20 stored in the module storage area of the storage section 250, so that the module table 20 is updated.

Next, after the module editing processing in Step S110, or when the information input by the user's input operation at the input unit 220 for not editing the module information is recognized in Step S108, the processor 270 determines whether or not to create a web file based on the template information 11 and the module information 21 (Step S111). Specifically, when the information recognizer 271 recognizes information indicating that the start button 31A is selected by the user's input operation at the input unit 220 in the template editing window 30 or the preview window 50, the processor 270 determines to create the web file.

Then, when the processor 270 determines to create the web file in Step S111, the processor 270 controls the file creating section 276 to create the web file (Step S112) Specifically, the file creating section 276 recognizes the template category information 14 of the template information 11 and then recognizes the template information 11 having common template category information 14. Then, referring to the placement module information 17C of these template information 11, the file creating section 276 recognizes the module information 21 that is associated with these template information 11. Thereafter, the file creating section 276 constructs the layout of the web file by, for instance, a table tag based on the placement position coordinate information 17B of the layout information 16 of the template information 11 and embeds the module details information 25 of the module information 21 in a layout frame formed by the table tag. Further, the file creating section 276 performs the same processing as described above on the recognized template information 11, embeds the module information 21 therein and creates web files of the numbers corresponding to the template information 11.

After Step S112, or when the information for not creating the web file is recognized in Step S111, the processor 270 determines whether or not to transmit the web file or other various information to the server 300 (Step S113). Herein, the processor 270 determines whether or not the file transfer button 31J is selected by the user's input operation in the template editing window 30 or the preview window 50, and when recognizing the information indicating that the file transfer button 31J is selected, the processor 270 determines that the user requests the file transfer.

Then, in Step S113, when the file transfer button 31J is selected, the processor 270 operates the file transferer 277 to transmit a predetermined web file to the server 300 (Step S114). Specifically, the file transferer 277 of the processor 270 recognizes the server information from the transferring-direction setting information to identify the server 300 from the address information of the server 300. Then, based on server user information, the processor 270 transmits the authentication ID and the authentication password to the server 300. Then, when receiving information for access permission from the server 300, the processor transmits the web file created in Step S112, image information and sound information required for displaying the web file and other various information from the communicator 210 to the server 300 via the network 110. At this time, the processor 270 transmits the initial directory information together with the web file and the various information.

Thereafter, the processor 270 determines whether or not information for continuing the web-file creation processing is recognized (Step S115). When the information recognizer 271 recognizes information for terminating the web-file creation processing, the processor 270 terminates the processing. On the other hand, when the information recognizer 271 recognizes the information for continuing the web-file creation processing, the processor 270 performs processing of step S104 to display the preview window 50 in the display area of the display section 230.

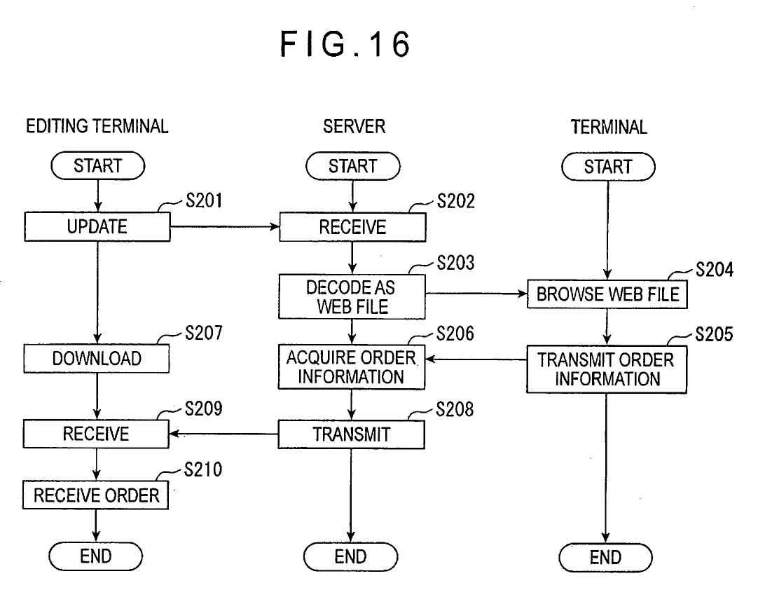

Next, order-receiving processing in the information processing system 100 will be described referring to FIG. 16. FIG. 16 is a flow chart showing order-receiving processing of the information processing system 100.

First in FIG. 16, the editing terminal 200 transmits the web file created in the web-file creation processing in FIG. 15 and the various information to the server 300 as the processing of Step S114 (Step S201).

When the server 300 receives the web file, the various information and the initial directory information from the editing terminal 200 (Step S202), the server 300 stores the received web file and various information in a predetermined storage area in the storage section 340.

Next, the CPU 350 of the server 300 operates the web processing section 351 to make the web file received in Step S202 and stored in the storage section 340 browsable via the network so as to publicize the web file in the network 110 (Step S203). Then, when recognizing request information for browsing the web file from the terminal 400 or the editing terminal 200, the web processing section 351 of the server 300 transmits the web file to the terminal 400 or the editing terminal 200 in accordance with the request information.

When an input signal for browsing the web file is input to the processing unit by the input operation of the orderer at the input operation section, the terminal 400 controls the transmitter/receiver to acquire the web file publicized in the network 110 in Step S203 from the predetermined storage area in the server 300. Then, the processing unit of the terminal 400 runs the web-browsing client software and displays the acquired web file as a web window as shown in FIGS. 10 to 12 in the display area of the terminal display section (Step S204).

Here, in the web top window 70 as shown in FIG. 10 that is displayed on the terminal display section of the terminal 400, when the orderer operating the terminal 400 transmits to the server 300 information for browsing details of a predetermined article, the server 300 transmits a web file that can display the web article description window 80 as shown in FIG. 11 to the terminal 400. When, for instance, “Add to Cart” button is selected in the web article description window 80 by the orderer's input operation at the input operation section, the processing unit of the terminal 400 transmits to the server 300 article purchase plan information indicating that a purchase of a predetermined article planned. The server 300, in response to the article purchase plan information, operates the web processing section 351 to compute total purchase price for the selected article. Then, the server 300 transmits to the terminal 400 a web file for displaying the computed total purchase price. In addition, the processing unit of the terminal 400 displays, based on the received web file, the web article purchase window 90 as shown in FIG. 12 in the terminal display section to display guidance information for prompting the orderer to input the order information. When recognizing the order information input by the orderer's input operation, the terminal 400 transmits the order information to the server 300 (Step S205).

When the server 300 receives the order information transmitted from the terminal 400 in Step S205 (Step S206), the server 300 controls the order processing section 352 of the CPU 350 to readably store the received order information in a predetermined order storage area in the storage section 340. At this time, specific information such as an IP address for identifying the terminal 400 that has transmitted the order information is also stored. When recognizing that an e-maul as a contact address is contained in the received order information, the CPU 350 of the server 300 controls the e-mail sending section 353 to transmit notification information for notifying the reception of the order information to the recognized e-mail address. Further, the e-mail sending section 353 transmits notification information for notifying the reception of the order information to the editing terminal 200.

Meanwhile, when the editing terminal 200 recognizes information indicating that the download button 31K is selected by the user's input operation when the template editing window 30 or the preview window 50 is displayed in the display area of the display section 230 (Step S207), the editing terminal 200 reads server information corresponding to the predetermined server 300 from the transferring-direction setting information. The file transferer 277 of the processor 270 transmits to the predetermined server 300 the authentication ID and the authentication password based on the server information to access the server 300, and transmits request information for receiving the order information to the server 300. The server 300 controls the interface 310 to transmit the predetermined order information to the editing terminal 200 (Step S208). After transmitting the order information to the editing terminal 200, the server 300 deletes the transmitted order information from the storage section 340. Note that the editing terminal 200 may delete the order information only when request information input by the user's input operation for deleting the order information is received.

When the editing terminal 200 receives the order information transmitted from the server 300 (Step S209), the display controller 273 controls the display section 230 to display the web order management window 60 as shown in FIG. 9. Thereafter, when recognizing the input signal for editing the order information input by the user's input operation, the order operating section 278 of the processor 270 changes the order status of the order information accordingly (Step S210).

[Advantage of Information Processing System]

In the above-described embodiment of the information processing system 100, the file creating section 276 of the editing terminal 200 recognizes the module information 21 associated with the placement module information 17C of the template information 11 and creates a web file in which the module details information 25 of the associated module information 21 is embedded in a coordinate position corresponding to a placement coordinate position of the template information 11. Accordingly, the web file can be easily created using the module information 21 having been prepared in advance. Thus, when the user desires to change a part, e.g., a title, used in a plurality of web files, the user is only required to edit the module details information 25 of the module information 21 corresponding to the part desired to be changed and to create the web file with the edited module information 21 being embedded in the template information 11. Therefore, unlike conventional arrangements in which the same editing has to be repeated for each of the plurality of web files, the web file can be created easily only by clicking the start button 31A by mouse in the template editing window 30 or the preview window 50.

In frame structures of the conventional web files, since the plurality of web files are linked to each frame, a so-called robot search engine for searching for a part of a text document in web files can only search for one web file out of the plurality of web files displayed in the frame. Accordingly, when the user desires to advertise a shop in a webpage or to open an online shopping site for purchasing/selling articles on the network 110, with the webpage having such conventional frame structure, the robot search engine might not search for the text document thoroughly but leave a part thereof unsearched. On the other hand, the file creating section 276 of the editing terminal 200 of the above-described embodiment creates a web file with details of plural pieces of module information 21 being embedded in a layout frame based on the placement position information 17 of the template information 11. Thus, all the text documents contained in the web file can be searched for by the robot search engine. Therefore, effective advertising for web files can be performed by the robot search engine or the like.

The file creating section 276 creates, from plural pieces of template information 11 and the module information 21 associated with the placement module information 17C of the plural pieces of template information 11, the plurality of web files corresponding to the plural pieces of template information 11 at one time. Accordingly, a bothersome work for creating a web file individually for each piece of template information 11 can be saved. Thus, the plurality of web files can be easily created at one time only by selecting the start button 31A in the template editing window 30 or the preview window 50. Therefore, the user's work can be reduced and thus can create the web files more quickly and more smoothly.

Furthermore, plural pieces of module information 21 may be associated with the placement module information 17C of the template information 11. With the arrangement, the file creating section 276 can create a web file with the module details information 25 of the plural pieces of module information 21 embedded in the layout frame 34A. Therefore, it is not necessary to provide the placement position information 17 set for the template information 11 in accordance with a position where each piece of the module information 21 is placed, even a web file with complicated layout can be created easily.

When the information recognizer 271 recognizes that a module name in the module-name display section 36C of the module list section 36 is moved to the layout frame 34A by drag-and-drop using the input unit 220 such as a mouse, the template editor associates the placement module information 17C with the module information 21 corresponding to the moved module name. Thus, the user can easily associate the placement module information 17C with the module information 21 through a simple operation. Therefore, the web file can be created even more easily.

Further, the display controller 273 displays the web file created by the file creating section 276 as the preview window 50. Thus, the user can easily check the created web file and the edited part. Therefore, the user can be effectively supported in creating web files.

The display controller 273 divides the display area of the template editing window 30 into three zones, where the left zone displays the list section 32 for displaying the template listing section 32A, the right zone displays the module list section 36 and the center display section 34 displays the layout frame 34A, the screen configuration information 34C, the template-name display section 34D, the module-placement deleting button 34E, the layout change button 34F and the like. Thus, the user can easily check the template information 11 displayed in the center display section 34 in the template listing section 32A, while easily checking the module information 21 associated with the layout frame 34A in the center display section 34 in the module list section 36. Further, only by moving the module-name display section 36C displayed in the module list section 36 to the layout frame 34A by drag-and-drop, the module information 21 can be easily associated with the placement module information 17C of the template information 11. Therefore, the window that allows the user to check and operate easily can be displayed, thus supporting the user more effectively in creating web files.

Moreover, the display controller 273 divides the display area of the preview window 50 into three zones, where the left zone displays the site map 51 displayed in the list section, the right zone displays the module list section 36, and the center display section 34 displays the preview information 53. Thus, by selecting a web file displayed on the site map, a preview of the web file can be easily browsed. Therefore, the window that allows the user to check and operate easily can be displayed.

The file creating section 276 creates web files in the HTML format. Since the HTML that is easily created and generally used for a webpage is employed, processing load for creation can be reduced. With the HTML format, table structures can be easily created using a table tag, so that layout structure of a webpage can be easily formed. In addition, usage of the HTML helps the user's understanding of details, so that the user can directly edit the web file written in the HTML with ease. Therefore, for instance, when the user desires to use instruction tag information of higher level, the user can edit the web file written in the HTML with ease, so that the user can create a web file with desired design.

The server 300, when receiving the order information from the terminal 400, transmits information for notifying the reception of the order information to the e-mail address contained in the order information by an automatic reply. Thus, the orderer using the terminal 400 can confirm that the order information is received. Therefore, the orderer can purchase/sell articles via the network 110 at ease, which enhances reliability of online shopping.

Further, the server 300, when receiving the order information from the terminal 400, transmits information for notifying the reception of the order information to the editing terminal 200 or an e-mail address of the user. Therefore, the user can promptly confirm the order from the orderer, thereby promptly responding to the order.

Modification of Embodiment

Note that the present invention has been described above with reference to the embodiment, the scope of the invention is not limited thereto and includes various modifications as long as an object of the present invention can be achieved.

Specifically, although the editing terminal 200 creates a webpage for online shopping in the embodiment above, the arrangement is not limited thereto. For instance, the editing terminal 200 may be used to create various kinds of webpages such as a personal webpage and a group webpage.

A webpage to be created may be written in any language such as the XML without limiting to the HTML as described above.

Although after a web file is created by the file creating section 276, the information recognizer 271 recognizes information input by the user's input operation at the input unit 220 for transferring the web file to the server 300, the file transferer 277 transfers the web file to the server 300 in the above embodiment, the arrangement is not limited thereto. For instance, it may be so arranged that the web file is transferred to the server 300 at the same time with the creation of the web file at the file creating section 276.

The server 300 may also include a file creating section. In such arrangement, the editing terminal 200 operates the file transferer 277 to transfer to the server 300 template information 11 and module information 21 associated with placement module information 17C of the template information 11. Then, the server 300 creates a web file according to the template information 11 based on the transferred template information 11 and module information 21, the created web file then being stored in a predetermined storage area. Even in the arrangement, the web file is automatically created by the server 300 only by creating the template information 11 and the module information 21, so that the user can easily create the web file without necessity of editing the web file.

Although, based on template information 11 having the common template category information 14 and module information 21 associated with the placement module information 17C of these template information 11, file creating section 276 creates a web file corresponding to these template information 11 in the above embodiment, the arrangement is not limited thereto. As an example, when editing module information 21 of the existing web file, the file creating section 276 may recognize template information 11 having placement module information 17C with which the edited module information 21 is associated and create a web file corresponding to the recognized template information 11. In such arrangement, since only the web file that corresponds to the template information 11 corresponding to the updated module information 21 is edited, processing load and processing time for web creation can be reduced.

As another example, the file creating section 276 may create a web file corresponding to template information 11 edited by the template editor 274. In this case, as in the arrangement above, the processing load and the processing time for web creation can also be reduced.

Although the display controller 273 divides the display areas in the template editing window 30 and the preview window 50 respectively into three zones to separately display the list section 32, the center display section 34 and the module list section 36, the arrangement is not limited thereto. For instance, the list section 32 and he module list section 36 may be displayed in different windows, or the display may be switched between the list section 32, the center display section 34 and the module list section 36 using a window-switching tab or the like.

The file transferer 277 may also receive, without limiting to the order information, web files stored in the server 300 as described above.

Although the order information transferred by the file transferer 277 can be edited by the order operating section 278, the arrangement is not limited thereto. For instance, when a personal webpage is desired to be created, the file transferer 277 may download log files for a bulletin board, a chat and the like, and the order operating section 278 may display or edit details of the log files.

Although, in the information processing system 100 of the above embodiment, the web-file creation processing includes the template editing, the module editing, the web file creation and the updating in the order of description from Steps S104 to 115, the arrangement is not limited thereto. For instance, the user may arbitrarily perform the template editing, module editing, web file creation and updating in the preview window 50 being displayed. In such arrangement, after the module editing, the template editing may be performed, and the module editing may further be performed thereafter. The arrangement allows the user to determine a design of a web file while arranging layouts of templates and modules to be embedded in the layout frame.

While the functions are realized in the form of programs in the above description, the functions may be realized in any form including hardware such as a circuit board or an element such as IC (Integrated Circuit). In view of easy handling and promotion of the use, the functions are preferably stored and read from programs or recording media.

Specific structures and procedures of embodiment of the present invention can be also changed as long as an object of the present invention can be achieved.

[Advantage of Embodiment]

In the above-described embodiment of the information processing system 100, the file creating section 276 of the editing terminal 200 recognizes the module information 21 associated with the placement module information 17C of the template information 111 and creates a web file in which the module details information 25 of the associated module information 21 is embedded in a coordinate position corresponding to the placement coordinate position of the template information 11. Accordingly, the web file can be easily created using the module information 21 having been prepared in advance. Therefore, unlike conventional arrangements in which the same editing has to be repeated for each of the plurality of web files, the web file can be created easily.

The priority application Number JP-A-2005-114807 upon which this patent application is based is hereby incorporated by reference.

What is claimed is:

1. An information processing device, comprising:
a details information recognizer for recognizing details information about details of content;
a template recognizer for recognizing plural pieces of template information having at least one piece of embedding frame information about an information embedding frame in which the details information is embedded;
an information associator for selecting the details information that is embedded to the information embedding frame of the embedding frame information and associating the embedding frame information with the selected details information; and
an information generator for generating content information for each of the plural pieces of template information, the content information being constructed as a single data structure in which, based on the template information and the details information associated with the embedding frame information of the template information, details of the details information associated with the embedding frame information is embedded in the information embedding frame.

2. The information processing device according to claim 1, wherein
the information generator generates plural pieces of the content information corresponding to the plural pieces of template information at one time.

3. The information processing device according to claim 1, wherein
the information associator associates the plural pieces of details information with the embedding frame information, and
the information generator generates the content information constructed as a single data structure in which the plural pieces of details information are embedded in the information embedding frame.

4. The information processing device according to claim 1, further comprising
an operating section provided in a manner usable in an input operation, the operating section outputting an operation signal in accordance with the input operation, wherein
the information associator associates the details information with the embedding frame information of the template information in accordance with the operation signal from the operating section.

5. The information processing device according to claim 4, further comprising
a details information editor for editing the details information in accordance with the operation signal from the operating section, wherein
the information generator generates the content information based on the details information edited by the details information editor and the template information having the embedding frame information associated with the details information.

6. The information processing device according to claim 4, further comprising
a template editor for editing placement of the information embedding frame of the template information in accordance with the operation signal of the operating section, wherein
the information generator generates the content information based on the template information edited by the template information editor and the details information associated with the embedding frame information of the template information.

7. The information processing device according to claim 1, further comprising
a display controller for controlling display unit to display the content information generated by the information generator.

8. The information processing device according to claim 7, wherein
the display controller divides a display area of the display section into zones and controls the display unit to display a template listing image for listing the plural pieces of template information, a module listing image for listing the module information and a content display image for displaying the content information respectively in the divided zones.

9. The information processing device according to claim 8, wherein
the embedding frame information has position coordinate information about a position coordinate to which the information embedding frame is placed, and
the display controller switches display to any one of the content display image and a template listing window for displaying the information embedding frame on a predetermined coordinate position corresponding to the position coordinate information.

10. The information processing device according to claim 1, wherein
the content information is a web file for constructing a webpage that is browsable on a network, and
the information generator generates the web file using instruction tag information written in a predetermined document description language based on the template information and the details information associated with the embedding frame information of the template information.

11. The information processing device according to claim 10, wherein the information generator generates a web file using table tag information for constructing a table frame with a shape corresponding to the information embedding frame of the embedding frame information, the web file being constructed as a single data structure in which the details information is embedded in the table frame constructed by the table tag information.

12. An information processing system, comprising:
an editing device having an information processing device; and
a server that is connectable to the editing device via a network, the server having a storage section for storing the content information transmitted from the editing section so that the content information is browsable on the network, wherein
the information processing device includes:
a details information recognizer for recognizing details information about details of content;
a template recognizer for recognizing plural pieces of template information having at least one piece of embedding frame information about an information embedding frame in which the details information is embedded;
an information associator for selecting the details information that is embedded to the information embedding frame of the embedding frame information and associating the embedding frame information with the selected details information; and
an information generator for generating content information for each of the plural pieces of template information, the content information being constructed as a single data structure in which, based on the template information and the details information associated with the embedding frame information of the template information, details of the details information associated with the embedding frame information is embedded in the information embedding frame.

13. The information processing system according to claim 12, wherein
the information generator of the editing device creates the content information and transmits to the server the content information at the same time of the creation.

14. An information processing system, comprising:
a server having an information processing device; and
a communicator that is connectable to the server via the network, the communicator transmitting the template information and the details information to the server, wherein
the information processing device includes:
a details information recognizer for recognizing details information about details of content;
a template recognizer for recognizing plural pieces of template information having at least one piece of embedding frame information about an information embedding frame in which the details information is embedded;
an information associator for selecting the details information that is embedded to the information embedding frame of the embedding frame information and associating the embedding frame information with the selected details information; and
an information generator for generating content information for each of the plural pieces of template information, the content information being constructed as a single data structure in which, based on the template information and the details information associated with the embedding frame information of the template information, details of the details information associated with the embedding frame information is embedded in the information embedding frame.

15. An information processing method, comprising:
recognizing details information about details of content,
recognizing plural pieces of template information having at least one piece of embedding frame information about an information embedding frame in which the details information is embedded,
selecting the details information that is embedded to the information embedding frame of the embedding frame information and associating the embedding frame information with the selected details information; and
generating content information for each of the plural pieces of template information, the content information being constructed as a single data structure in which, based on the template information and the details information associated with the embedding frame information of the template information, details of the details information associated with the embedding frame information is embedded in the information embedding frame.

16. An information processing program for operating a computing unit to function as an information processing device, the information processing device including:
a details information recognizer for recognizing details information about details of content;
a template recognizer for recognizing plural pieces of template information having at least one piece of embedding frame information about an information embedding frame in which the details information is embedded;
an information associator for selecting the details information that is embedded to the information embedding frame of the embedding frame information and associating the embedding frame information with the selected details information; and
an information generator for generating content information for each of the plural pieces of template information, the content information being constructed as a single data structure in which, based on the template information and the details information associated with the embedding frame information of the template information, details of the details information associated with the embedding frame information is embedded in the information embedding frame.

17. An information processing program for operating a computing unit to execute an information processing method, the method including:
recognizing details information about details of content,
recognizing plural pieces of template information having at least one piece of embedding frame information about an information embedding frame in which the details information is embedded,
selecting the details information that is embedded to the information embedding frame of the embedding frame information and associating the embedding frame information with the selected details information; and
generating content information for each of the plural pieces of template information, the content information being constructed as a single data structure in which, based on the template information and the details information associated with the embedding frame information of the template information, details of the details information associated with the embedding frame information is embedded in the information embedding frame.

18. A recording medium recording an information processing program in a manner readable by a computing unit, the operation processing program operating the computing unit to function as an information processing device, wherein
the information processing device includes:
a details information recognizer for recognizing details information about details of content;
a template recognizer for recognizing plural pieces of template information having at least one piece of embedding frame information about an information embedding frame in which the details information is embedded;
an information associator for selecting the details information that is embedded to the information embedding frame of the embedding frame information and associating the embedding frame information with the selected details information; and
an information generator for generating content information for each of the plural pieces of template information, the content information being constructed as a single data structure in which, based on the template information and the details information associated with the embedding frame information of the template information, details of the details information associated with the embedding frame information is embedded in the information embedding frame.

19. A recording medium recording an information processing program in a manner readable by a computing unit, the operation processing program operating the computing unit to execute an information processing method, wherein
the method includes:
recognizing details information about details of content,
recognizing plural pieces of template information having at least one piece of embedding frame information about an information embedding frame in which the details information is embedded,
selecting the details information that is embedded to the information embedding frame of the embedding frame information and associating the embedding frame information with the selected details information; and
generating content information for each of the plural pieces of template information, the content information being constructed as a single data structure in which, based on the template information and the details information associated with the embedding frame information of the template information, details of the details information associated with the embedding frame information is embedded in the information embedding frame.
